(19) United States
(12) Patent Application Publication
(10) Pub. No.: US 2006/0053045 A1
(43) Pub. Date: Mar. 9, 2006

(54) System and method for targeted marketing to scientific researchers

(76) Inventors: Nathan Amis Danielson, St. Louis, MO (US); Marc Richard Shiker, Overland Park, KS (US); James Wilson Watters, Chalfont, PA (US)

Correspondence Address: James Wilson Watters, 320 Stony Hill Dr, Chalfont, PA, 18914, US

(21) Appl. No.: 11/116,478

(22) Filed: Apr. 29, 2005

Related U.S. Application Data
(60) Provisional application No. 60/606,920, filed on Sep. 3, 2004.

(51) Int. Cl. G06F 17/30

(52) U.S. Cl. 705/10

(57) ABSTRACT

A marketing system comprising a receiving means for receiving a request for researcher characteristics from a database comprising an array of researcher characteristics, a filtering means for filtering the array of researcher characteristics in order of relevance to the requested characteristics, and delivery means for delivering the relevant filtered researcher characteristics derived from the filtered array. Marketers search a database containing information pertaining to scientific researchers, including recent grant applications, recent publications, history of attending research-oriented events, purchase history of the laboratory, research focus of the laboratory, techniques used under the research focus, geography, contact information for members of the laboratory, services provided by the laboratory, world wide web address associated with the laboratory, individual and group research survey information, equipment, consumables and software accessible to the individual or group, URL, and any combination thereof. An algorithm ranks matches by relevance to the marketer-specified search criteria, and specific information pertaining to database matches is filtered and delivered to the marketer. Targeted marketing campaigns can be directed toward potential customers based on retrieved information.

### CROSS-REFERENCE TO RELATED APPLICATIONS

This application claims the benefit of U.S. Patent Provisional Application No. 60/606,920 filed on Sep. 3, 2004 and is incorporated herein by reference.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

1. Field of Invention

This invention relates generally to the development of effective marketing strategies based on specific customer characteristics. More specifically, the invention is a method involving the targeted marketing of products to scientific researchers, based on specific customer characteristics ascertained through database searching.

2. Related Art

Currently, organizations that wish to market products/services related to scientific research pursue one or more of the following strategies:
1) Hire a dedicated sales force. This is not cost-effective for small businesses, and some businesses sell items that have too low a margin to justify a dedicated sales force.
2) Use a distributor. Distributors charge as much as 50% overhead, dramatically decreasing profits to the manufacturer (e.g., VWR, Sigma-Aldrich, Intermountain Scientific, and the like).
3) Do a direct or mass mailing. This is expensive and requires the purchase of an address list, which often contains no information about the targeted customer, and therefore has the disadvantage of being random (e.g., Biotechniques, American Laboratory, Nature, and the like).
4) Advertise in trade publications. Flagship publications are prohibitively expensive, and this option is therefore out of the reach of many small businesses (multiple science companies).
5) Purchase advertising on the Internet. The problems associated with Internet marketing are that it will only indirectly target an audience for such marketing and is reliant on an Internet Marketer to find such marketing on a related web site. Double click uses an Internet marketing technique, but Marketers typically are wary of having spyware on their computers to capture click through and have such patterns transmitted to an unknown third party (e.g., Biotechniques, Biocompare, Google, and the like).
6) Spam e-mailing. The problem with spam is it is inherently inaccurate, does not target an audience, and is more frequently isolated by e-mail programs, e.g. spam filters, such that the audience will likely never see the marketing.
7) Trade shows. This form of marketing is expensive and is reliant on the customer physically approaching the marketing rather than the marketing pushing toward the customer.
8) Telemarketing. The problem with telemarketing is the lack of specific information about a potential Marketer, and many states are enacting laws to outlaw such marketing. In addition, such marketing has been shown to have a very low success rate.
9) Direct Fax. Again, this type of advertising is becoming illegal in many parts of the world and displays low accuracy when most researchers do not have fax machines in the laboratory.

Each of the techniques used above, either individually or in combination, do not accurately or precisely target an audience which is likely to purchase goods or services. Therefore, a problem currently exists in the art whereby such targeting is inefficient, costly and notoriously unreliable. Accordingly, what is needed is a method of marketing to researchers which is efficient, cost-effective, and both more accurate and precise.

### BRIEF SUMMARY OF THE INVENTION

Accordingly, it is an object of the invention to overcome these and other problems associated with the related art. These and other objects, features and technical advantages are achieved and accomplished by enabling marketers to identify customers based upon criteria that are directly relevant to product offerings.

The invention provides a marketing system comprising a receiving means for receiving a request for at least one researcher characteristic from a database comprising an array of researcher characteristics, said array comprising researcher characteristics meeting marketer criteria for predicting a likelihood of future sales to the researcher, a filtering means for filtering the array of researcher characteristics in order of relevance to the requested characteristic, and delivery means for delivering the relevant filtered researcher characteristics derived from the filtered array.

In accordance with one aspect of the invention, the filtering means comprises an algorithm for analyzing researcher characteristics within the database. Preferably, the algorithm ranks researcher characteristics selected from the group consisting of recent grant applications, recent publications, history of attending research-oriented events, purchase history of the laboratory, research focus of the laboratory, techniques used under the research focus, geography, contact information for members of the laboratory, services provided by the laboratory, world wide web address associated with the laboratory, individual and group research survey information, equipment, consumables and software accessible to the individual or group, URL, and any combination thereof. More preferably, the algorithm is represented by the formula: A1*A2*A3*A4*A5*A6 . . . *A∞, where A represents the number of times the Marketer-specified search term(s) is(are) found in the corresponding data table(s) for each of the fields (fields 1, 2, 3, 4, 5, 6 . . . ∞) used to search the database.

In accordance with a further aspect of the invention, the array comprises at least one set of researcher characteristics. Preferably, the set of researcher characteristics is populated with at least one characteristic. More preferably, the characteristic is selected from the group consisting of recent grant applications, recent publications, history of attending research-oriented events, purchase history of the laboratory, research focus of the laboratory, techniques used under the research focus, geography, contact information for members of the laboratory, services provided by the laboratory, world wide web address associated with the laboratory, individual and group research survey information, equipment, consumables and software accessible to the individual or group, URL, and any combination thereof.

In accordance with yet another aspect of the invention, the database retains and stores researcher characteristics. Preferably, the database architecture is selected from the group consisting of SQL, ASP, Cold Fusion, Sparc, Microsoft Access, Oracle and DB2.

In accordance with yet another aspect of the invention, the receiving means allows for the receipt of a request for at least one researcher characteristic from the database. Preferably, the receiving means is selected from the group consisting of a graphical user interface, telephonic marketer-to-marketer interface, text based interface, and any combination thereof.

In accordance with yet another aspect of the invention, the delivery means allows for delivery of the relevant filtered researcher characteristics derived from the filtered array. Preferably, the delivery means is selected from the group consisting of e-mail, graphical user interface, fax, and any combination thereof.

This invention also provides a method for generating revenue comprising selling the set of filtered researcher characteristics derived from the system comprising a receiving means for receiving a request for at least one researcher characteristic from a database comprising an array of researcher characteristics, said array comprising researcher characteristics meeting marketer criteria for predicting a likelihood of future sales to the researcher, a filtering means for filtering the array of researcher characteristics in order of relevance to the requested characteristic, and delivery means for delivering the relevant filtered researcher characteristics derived from the filtered array.

This invention also provides a method for generating revenue comprising selling the system comprising a receiving means for receiving a request for at least one researcher characteristic from a database comprising an array of researcher characteristics, said array comprising researcher characteristics meeting marketer criteria for predicting a likelihood of future sales to the researcher, a filtering means for filtering the array of researcher characteristics in order of relevance to the requested characteristic, and delivery means for delivering the relevant filtered researcher characteristics derived from the filtered array.

The invention also provides a method for generating revenue comprising selling access to the system comprising a receiving means for receiving a request for at least one researcher characteristic from a database comprising an array of researcher characteristics, said array comprising researcher characteristics meeting marketer criteria for predicting a likelihood of future sales to the researcher, a filtering means for filtering the array of researcher characteristics in order of relevance to the requested characteristic, and delivery means for delivering the relevant filtered researcher characteristics derived from the filtered array.

These and other features, aspects and advantages of the present invention will become better understood with reference to the following description, examples and appended claims.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 illustrates the design of the database and data relationships among database tables. FIG. 1 is a Ktulu entity relationship diagram describing the tables comprising the database, the relationships among tables, and the names of variables in said tables.

FIG. 2 illustrates the favored embodiment of how the database would be used to identify prospective customers.

FIG. 3 illustrates the favored embodiment of how the database would be used to identify prospective customers from among those attending specific conferences.

### DETAILED DESCRIPTION OF THE INVENTION

Definitions

To facilitate understanding of the invention, a number of terms and abbreviations as used herein are defined below as follows:

Marketer: The term “marketer” shall mean any entity engaged in advertising, sales, etc. Such term shall also include employment recruiters engaged in determining employment opportunities based upon individual characteristics.

Trend analysis: As the database is populated, predictive methods may be developed to extrapolate the probability of future researcher purchases.

Application of a System and Method for Targeted Marketing to Scientific Researchers

The present invention provides a marketing system and methods for generating revenue comprising providing an enhanced system for marketing to scientific researchers allowing for the efficient, cost-effective, accurate and precise targeting of potential customers engaged in scientific research. The methods capture revenue at multiple points within the business stream: first, a company selling software which assists in performing the methods generates revenue; second, marketers using the methods generate revenue above prior art methods derived through the previously uncaptured efficiencies and enhanced targeting of customers. Such methods accomplish this through the creation of a searchable database where individual and group characteristics are analyzed. Such characteristics include, but are not limited to:
Recent grant applications
Recent publications
History of attending research-oriented events
Purchase history of laboratory
Research focus of the laboratory
Techniques used under the research focus
Geography
Contact information for members of the laboratory
Services provided by the laboratory
World wide web address associated with the laboratory
Individual and Group research survey information
Equipment, consumables and software accessible to the individual or group

Using an algorithm, a database of such characteristics is queried to return a ranked listing of results. A marketer querying the database may use the results to optimize a marketing strategy. Such optimized strategy allows individuals and groups to more efficiently and cost-effectively market products and services to researchers. Further features and advantages of the present invention, as well as the structure and operation of various embodiments of the invention, are described below with reference to accompanying drawings.

3.1. Design and Function of the Database

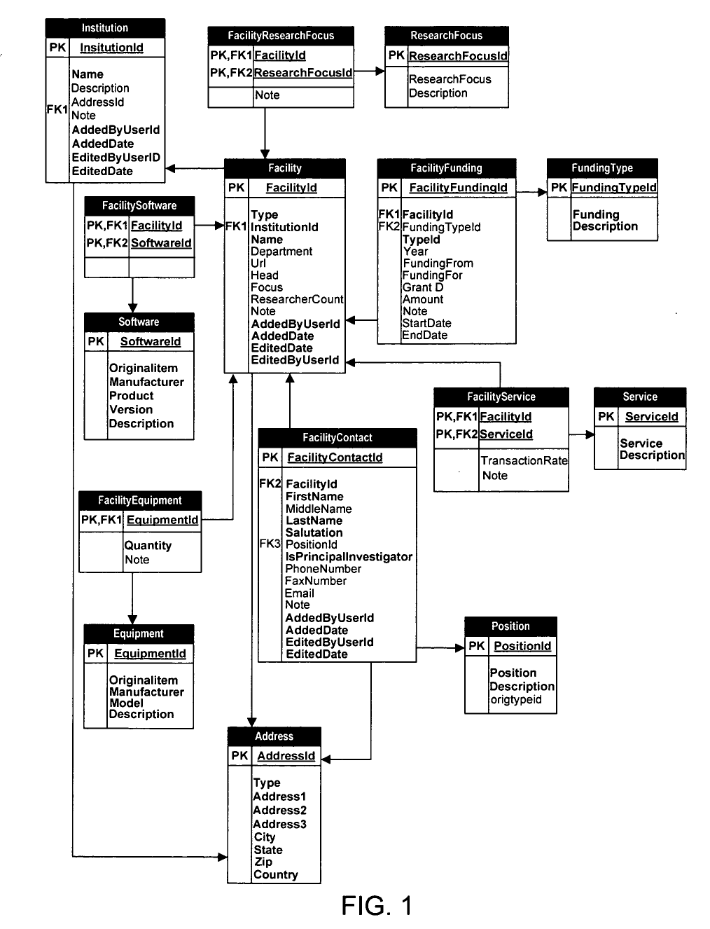

FIG. 1 illustrates the structure of one embodiment of a relational database constructed using SQL server technology. FIG. 1 describes the structure of the database, including table descriptions, variable names, and relationships between tables. Those of skill in the art will understand that many different conformations of software and databases including, but not limited to ASP, Cold Fusion, Sparc, Microsoft Access and any other databases capable of relating data sets to one another. It is also envisioned that real-time updating of customer purchasing and other characteristics will become possible in the future, allowing up-to-the-minute accuracy of customer data.

The database is populated with characteristics pertaining to specific research laboratories, organizations or other entities engaged in scientific research. As noted above, such characteristics include, but are not limited to:
Recent grant applications
Recent publications
History of attending or enrollment in research-oriented events
Purchase history of laboratory
Research focus of the laboratory
Techniques used under the research focus
Geography
Contact information for members of the laboratory
Services provided by the laboratory
World wide web address associated with the laboratory
Individual and Group research survey information
Equipment, consumables and software accessible to the individual or group

Other characteristics related to an individual's or group's purchase patterns or new technologies, which shape methods for trend analysis, are within the scope of the invention.

Information entered into the database covers specific research laboratories, organizations or other entities engaged in scientific research in disciplines defined by the following North American Industry Classification System (NAICS) codes:

| | |
|---|---|
| Research and Development in the | 541710 |
| Physical, Engineering, and Life | |
| Sciences | |
| Research and Development in the | 541720 |
| Social Sciences and Humanities | |

Likewise, other technologies which are not currently in NAICS codes, known or developed may be used in the invention and are, accordingly, within the scope of the invention. Example 1 below describes one such technology, i.e. nanotechnology.

Database entry is currently accomplished by Internet searching and data entry. Prospectively, automated entry of data into the database may be accomplished by Internet search methods, such as with “spidering” and other technologies. Specific data entered pertaining to database entrants includes:
Recent grant applications
Recent publications
History of attending or enrollment in research-oriented events
Purchase history of laboratory
Research focus of the laboratory
Techniques used under the research focus
Geography
Contact information for members of the laboratory
Services provided by the laboratory
World wide web address associated with the laboratory
Individual and Group research survey information
Equipment, consumables and software accessible to the individual or group

A preferred embodiment of Internet searching and database entry is provided in Exapmle 2 below. Those of skill in the art will recognize that additional forms of data entry exist, which include, but are not limited to: automated database searching, automated data entry, and automated database formation. For example, it is envisioned that software can be used which could query existing databases and selectively return information based on pre-determined query criteria. In one aspect of the above, it is envisioned that spider-like software could be used.

3.2 Using a Database to Identify Prospective Customers

After a database is created according to the description above, a Marketer may query such database using any known interface technologies. Such interfaces may include Graphical Marketer Interfaces (“GUI”), telephonic Marketer-to-Marketer interfaces, text based interfaces, and the like. The query is then used by an algorithm to find, rank and return results to the Marketer. Any database architecture and any software capable of ranking the data may be used in returning results to the Marketer. While a preferred embodiment of the algorithm is provided in Example 3 below, other algorithms may be adapted to changing customer and Marketer preferences, changing technologies, and other anticipated changes in the scientific market.

The algorithm may be developed to perform trend analysis for an individual or group.

Output: the output of the algorithm provides the Marketer a ranking of probable individuals and groups to target marketing. Such output may include, e.g., individual researcher names and geographical location. Other data may be provided according to the particular query and/or the consideration paid by the Marketer to obtain the output. Such additional data may include greater detail based upon the data entry or customer needs.

The output may be transmitted to the Marketer via e-mail, GUI or any other interface, fax and any other method available to one of skill in the art. In addition, updates of the output may be provided to the Marketer over a predetermined period of time via the same methods.

En toto, the query, algorithm and output may be housed on CD-ROM, DVD, stand alone, telecommunications, Internet-connected and/or networked computer systems.

### EXAMPLES

Without further elaboration, it is believed that one skilled in the art can, using the preceding description, utilize the present invention to its fullest extent. The following specific examples are offered by way of illustration and not by way of limiting the remaining disclosure.

### Example 1

Nanotechnology includes the following examples: 1) Nanowires. Nanowires are ultrafine wires, tens to hundreds of times finer than those produced by commercial micro-structure fabrication techniques, used for high-density data storage applications. 2) Nanotubes. Nanotubes are micron-scale tube structures composed of carbon atoms. Nanotubes have many applications, including DNA sequencing and the detection of DNA polymorphisms. 3) Quantum dots. One application of quantum dots is Qdot™, a multi-layered semiconductor nanocrystal attached to streptavidin, resulting in order-of-magnitude improvements in sensitivity, brightness, and stability or biological imaging applications.

### Example 2

As an example of Internet searching and database entry, consider the following: On Mar. 15, 2004, an individual initiates an Internet search for potential database entrants. Said individual accesses the web site http://www.google.com, and searches using the terms “Oklahoma State microarray core facility”. Said individual analyzes the search results, and finds the website for the Oklahoma State University microarray core facility, http://opbs.okstate.edu/core/arrayer/default.html. Now, said individual navigates this web site, and enters desired information into the database. Said individual is assigned the user ID jwatters. In this example, the following values are stored under the indicated variable names in the database:
InstitutionId: Oklahoma State University
   Name: Oklahoma State University
   Description: Oklahoma State University
   AddressId: see below
   Note: public university in Oklahoma
   AddedByUserId: jwatters
   AddedDate: 03152004
   EditedByUserId: none
   EditedDate: none
FacilityId: microarray core facility
   ResearchFocusId: see below
   Type: core facility
   Name: OSU microarray core facility
   Department: Biochemistry and Molecular Biology
   Url: http://opbs.okstate.edu/core/arrayer/default.html
   Head: Patricia Ayoubi, Ph. D.
   Focus: microarray expression profiling
   ResearcherCount: unknown
   Note: none
ResearchFocusId: microarray expression profiling
   ResearchFocusDescription: core facility offering genome-wide expression profiling services to investigators.
FacilityFundingId: Grants
   FacilityId: see above
   FundingTypeId: NIH grant for research resources
   TypeId: NIH grant
   Year: 2004
   FundingFrom:
   FundingFor:
   GrantID: 1P20RR16478-02
   Amount: unknown
   Note: none
   StartDate:
   EndDate:
FundingTypeId: NIH grant for research resources
SoftwareId: GenePixPro 3.0
   OriginalItem: no
   Manufacturer: Axon
   Product: GenePixPro
   Version: 3.0
   Description: microarray scanning software
EquipmentId: Packard Biochip Technologies ScanArray 3000
   OriginalItem: no
   Manufacturer: Hewlett Packard
   Model: ScanArray 3000
   Description: microarray scanner
FacilityContactId: Patricia Ayoubi, Ph. D.
   FirstName: Patricia
   MiddleName: unknown
   LastName: Ayoubi
   Salutation: Dr.
   PositionId: see below
   IsPrincipalInvestigator: Yes
   PhoneNumber: 405-744-6209
   FaxNumber: (405) 744-7799
   Email: ayoubi@okstate.edu
   Note: head of microarray core facility
ServiceId: Microarray construction, hybridization, analysis
   TransactionRate: unknown
   Note: none
   ServiceDescription: construction, hybridization, and analysis of microarrays.
PositionId: OMCF microarray specialist
   Position: OMCF microarray specialist
   Description: head of microarray core facility
   Origtypeid: none
AddressId: OSU microarray core address
   Type: core facility address
   Address1: 246 Noble Research Center
   Address2: Oklahoma State Univerisity
   Address3: none
   City: Stillwater
   State: OK
   Zip: 74078
   Country: USA

### Example 3

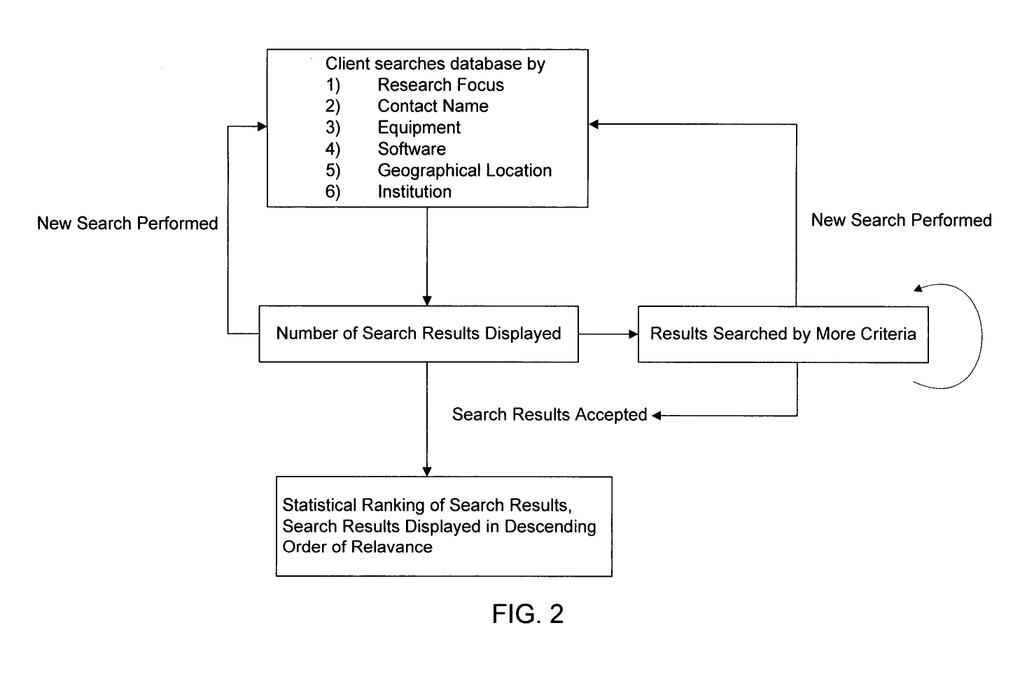

As an example of using the database to identify prospective customers, consider the following: FIG. 2 illustrates one embodiment of a Marketer querying a database to identify prospective customers. First, the Marketer initiates the database search at the INTRO SEARCH SCREEN. The INTRO SEARCH SCREEN will allow the Marketer to search the database by the following six fields:
Research Focus
Name
Equipment
Software
Geographical Location
Institution

Those of skill in the art will recognize that additional or different information may be requested on the search screen. All fields or a subset of fields may be entered by the Marketer and still obtain results. The database may be searched by one or more of these fields.

The number of database entries matching Marketer-specified search criteria is calculated in the following way: for each of the six fields that the Marketer can use to search in the INTRO SEARCH SCREEN, the query is associated with the relational database such that associated data are retrieved from the database.

For any of the six fields for which no search term was entered, the database will not search the corresponding data table(s). When all Marketer-defined search terms are found in the corresponding data table(s) for a particular database entry, that entry is considered to be a match in the database search. All Marketer-specified search terms must be found in the corresponding data tables for an entry to be considered a match. The database then displays the number of matches found for that set of search criteria on the SEARCH RESULTS SCREEN. The Marketer will then have several choices: SEARCH USING NEW TERMS, REFINE SEARCH or ACCEPT SEARCH RESULTS.

If the Marketer chooses SEARCH USING NEW TERMS then they are taken back to the INTRO SEARCH SCREEN, at which point the process begins anew. If the Marketer selects REFINE SEARCH, the originally returned search results can be re-searched by entering search terms into any number of new fields, or by specifying new search terms in previously searched fields. The database again performs the search described above, and returns information regarding the number of database entries that contain the new Marketer-specified search criteria AND the previously entered Marketer-specified search criteria on the REFINED SEARCH RESULTS SCREEN. The Marketer will again have several choices: SEARCH USING NEW TERMS, REFINE SEARCH or ACCEPT SEARCH RESULTS. The Marketer can choose SEARCH USING NEW TERMS or REFINE SEARCH as many times as desired.

When the Marketer is satisfied with the number of search results obtained, the Marketer selects ACCEPT SEARCH RESULTS. Next, a statistical algorithm is used to rank database entries that are considered to be matches based on how relevant they are to Marketer-specified search criteria. The statistical methodology used to rank the database entries matching the Marketer-specified search criteria will be: A1*A2*A3*A4*A5*A6 . . . *A∞, where A represents the number of times the Marketer-specified search term(s) is(are) found in the corresponding data table(s) for each of the fields (fields 1, 2, 3, 4, 5, 6 . . . ∞) used to search the database. Example: Marketer searches for RESEARCH FOCUS: MICROARRAY (AND) EQUIPMENT: ROBOTICS. In database entry X, the term microarray is found 4 times in the “research focus” table, and the term robotics is found twice in the “equipment” table. In such a case, the ranking statistic would be: 4*2=8. Those of skill in the art will recognize that additional or different algorithms could be used to rank database entries matching user-specified criteria.

Database entries considered to be matches are then displayed on the MATCH SCREEN. The MATCH SCREEN displays the matches is descending order of value for the ranking statistic, and displays the contact name for each entry that is considered to be a match. If two entries have the same value for the ranking statistic, they will be listed alphabetically according to the last name of the designated contact person.

The Marketer can then view information pertaining to the database entries that are considered to be matches. The contact information corresponding to each database match in the MATCH SCREEN will be an executable link that will allow the Marketer to see all other information for that particular entry in the database. This will be displayed in the DATABASE MATCH INFORMATION SCREEN.

The Marketer then has an option to ADD SEARCH TO SHOPPING CART. This option allows the Marketer to save searches that have been performed in a data table (described in section 3.1) that serves as a storage space for Marketer searches. The saved search is placed in the shopping cart as SEARCH TERM+(FIELD), SEARCH TERM+(FIELD), SEARCH TERM+(FELD), SEARCH TERM+(FIELD), SEARCH TERM+(FIELD), SEARCH TERM+(FIELD), DATE OF SEARCH.

The Marketer then markets directly to database entries based on information obtained from database mining. As a specific example of the above embodiment, consider the following:

BioComp Biological Software Corporation has developed a software product that controls microarray scanners. Their strategy is to sell to laboratories or other research organizations using microarray expression profiling for the classification of patient cancers, and for the prediction of chemotherapy response. BioComp is interested in searching the database for potential customers. BioComp goes to accesses the database, and enters the appropriate login information.

The INTRO SEARCH SCREEN allows BioComp to search the database by the following six fields:

INTRO SEARCH SCREEN

| | |
|---|---|
| Research Focus | 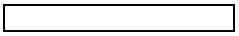 |
| Name | 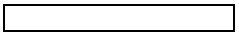 |
| Equipment | 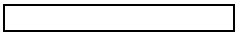 |
| Software | 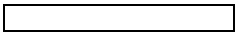 |
| Geographical Location | 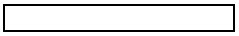 |
| Institution | 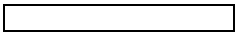 |

BioComp searches the database by RESEARCH FOCUS: Microarray (AND) EQUIPMENT: Scanner on Mar. 7, 2004.

The SEARCH RESULTS SCREEN returns the following:

| Search Terms | Number of Results |
|---|---|
| Microarray(Research Focus) + Scanner (Equipment) | 732 |

BioComp is presented with three options: SEARCH USING NEW TERMS, REFINE SEARCH or ACCEPT SEARCH RESULTS. In this example, the BioComp chooses to refine the search with the RESEARCH FOCUS term “Oncology”.

The REFINED SEARCH RESULTS SCREEN returns the following:

| | Number of |
|---|---|
| Search Terms | Results |
| Microarray(Research Focus) + Scanner (Equipment) + | 221 |
| Oncology(Research Focus) | |

BioComp is again presented with three options: SEARCH USING NEW TERMS, REFINE SEARCH or ACCEPT SEARCH RESULTS. In this example, BioComp chooses to accept the search results.

Search results are then ranked according to the following statistical algorithm: A1*A2*A3*A4*A5*A6 . . . *A∞, where A represents the number of times the Marketer-specified search term(s) is(are) found in the corresponding data table(s) for each of the fields (fields 1, 2, 3, 4, 5, 6 . . . ∞) used to search the database. BioComp is presented with a list of database matches on MATCH SCREEN, with the first match having the highest value for the ranking statistic, and the last match having the lowest value for the ranking statistic for all 221 search results. For purposes of this example, only results 1-10 are displayed below.

MATCH SCREEN

| Database Match | Ranking Statistic |
|---|---|
| Doe, John | 12 |
| Smith, Jane | 12 |
| Jones, Bob | 9 |
| Brown, Ed | 8 |
| Nickels, Roberta | 8 |
| Edwards, Jason | 7 |
| Richardson, Julie | 7 |
| Powers, Matthew | 6 |
| Johnson, Melissa | 4 |
| Doe, Jane | 3 |
| Etc. | |

BioComp is interested in the first match, so they click on the link “Doe, John”. BioComp is then taken to the DATABASE MATCH INFORMATION SCREEN. This screen returns the following:

DATABASE MATCH INFORMATION SCREEN
Database Match: Doe, John

| | |
|---|---|
| Research Focus | Whole-genome expression profiling using cDNA |
| | microarrays and oligonucleodite microarrays. The |
| | focus of the lab is mainly thoracic oncology and |
| | cervical oncology, specifically, tumor classification |
| | and pharmacogenomics. |
| Name/Contact Info | Name: John Doe |
| | Email: jdoe@im.wustl.edu |
| | phone: 314-362-2094 |
| | fax: 314-362-3764 |
| Equipment | Affymetrix 3100 microarray scanner |
| | Affymetrix 3200 microarray scanner |
| | Affymetrix scanner control station |
| | PSQ 96H pyrosequencer |
| | ABI 7700 SDS detection system |
| | Array printer |
| Software | Pyrosequencing PSQ H96 V1.0 |
| | Affymetrix analysis suite 5.0 |
| Geographical | 660 South Euclid Ave. |
| Location | St. Louis, MO 63110 |
| | USA |
| Institution | Washington University |
| Services | Genotyping |
| | HPLC chromatography |
| | HPLC/MS/MS chromatography |
| Funding Information | UO1 34217, “Comprehensive Research on |
| | Expressed Alleles in therapeutics” |
| | R21 87621, “Pharmacogenetic analysis of |
| | Candidate Gene Polymorphisms in NSCLC” |
| URL | http://pharmacogenetics.wustl.edu |

BioComp is then presented with the option to ADD SEARCH TO SHOPPING CART. In this example, BioComp chooses ADD SEARCH TO SHOPPING CART. The search is then saved as: Microarray (Research Focus)+Scanner (Equipment)+Oncology (Focus), Mar. 7, 2004.

BioComp then contacts John Doe by mail, using the address obtained from the DATABASE MATCH INFORMATION SCREEN, and offers their software product for sale.

### Example 4

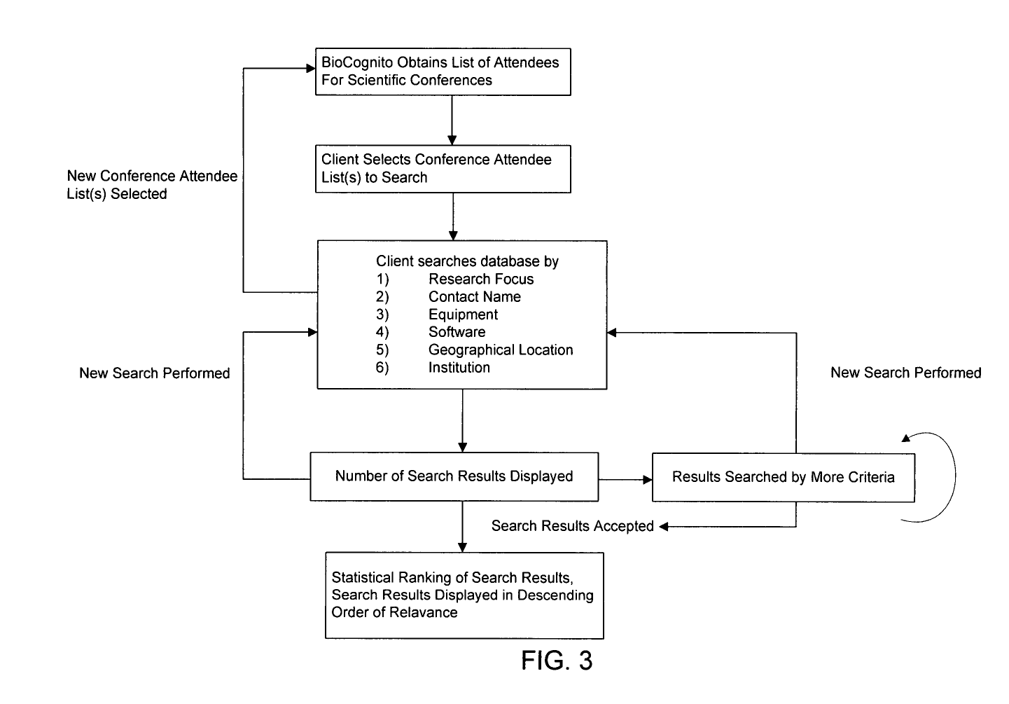

As an example of using the database to identify prospective customers from among those attending specific scientific conferences, consider the following: FIG. 3 illustrates the favored embodiment of how the database would be used to identify prospective customers from among those attending specific conferences. First, a list of attendee names from organizers of scientific conferences is entered into the database, before or after the conference has taken place, and cross-referenced with current database entries. Second, the Marketer uses the database to search specific conferences from which they wish to identify potential customers using the CONFERENCE SEARCH SCREEN. A drop-down list containing all searchable conferences will be available for the Marketer to select a conference from which to search. Third, the Marketer searches these attendee lists. The Marketer initiates this search at the INTRO SEARCH SCREEN. The INTRO SEARCH SCREEN will allow the Marketer to search the selected attendee list by the following six fields:
Research Focus
Name
Equipment
Software
Geographical Location
Institution

Those of skill in the art will recognize that additional or different information may be requested on the search screen. All fields or a subset of fields may be entered by the Marketer and still obtain results.

The selected conference attendee list can be searched by one or more of these fields. The number of database entries matching Marketer-specified conference search criteria is calculated in the following way: for each of the six fields that the Marketer can use to search in the INTRO SEARCH SCREEN, the query is associated with the relational database such that associated data are retrieved from the database For any of the six fields for which no search term was entered, the database will not search the corresponding data table(s). When all Marketer-defined search terms are found in the corresponding data table(s) for a particular database entry, that entry is considered to be a match in the database search. All Marketer-specified search terms must be found in the corresponding data tables for an entry to be considered a match.

The database then displays the number of matches found for that set of search criteria on the SEARCH RESULTS SCREEN. The Marketer will then have several choices: SEARCH NEW CONFERENCE, SEARCH USING NEW TERMS, REFINE SEARCH or ACCEPT SEARCH RESULTS.

If the Marketer chooses SEARCH NEW CONFERENCE, the Marketer is taken back to the CONFERENCE SEARCH SCREEN where a new search is initiated. If the Marketer chooses SEARCH USING NEW TERMS then they are taken back to the INTRO SEARCH SCREEN, at which point they can search the same conference attendee list with new search terms. If the Marketer selects REFINE SEARCH, the originally returned search results can be re-searched by adding any number of new fields, or by specifying new search terms in previously searched fields. The database again performs a search and returns information regarding the number of database entries that contain the new Marketer-specified search criteria AND the previously entered Marketer-specified search criteria on the REFINED SEARCH RESULTS SCREEN. The Marketer will again have several choices: SEARCH NEW CONFERENCE, SEARCH USING NEW TERMS, REFINE SEARCH or ACCEPT SEARCH RESULTS. The Marketer can choose SEARCH NEW CONFERENCE, SEARCH USING NEW TERMS, or REFINE SEARCH as many times as desired.

When the Marketer is satisfied with the number of search results obtained, the Marketer selects ACCEPT SEARCH RESULTS. The following statistical algorithm will be used to rank database entries considered to be matches: A1*A2*A3*A4*A5*A6 . . . *A∞, where A represents the number of times the Marketer-specified search term(s) is(are) found in the corresponding data table(s) for each of the fields (fields 1, 2, 3, 4, 5, 6 . . . ∞) used to search the database. Those of skill in the art will recognize that additional or different search algorithms could be used to rank database entries matching user-specified search criteria.

These database matches are then displayed on the MATCH SCREEN. The MATCH SCREEN displays the matches is descending order of value for the ranking statistic, and displays the contact name for each entry that is considered to be a match. If two entries have the same value for the ranking statistic, they will be listed alphabetically according to the name of the designated contact person.

The Marketer can then view information pertaining to the database entries that are considered to be matches. The contact information corresponding to each Database Match in the MATCH SCREEN will be an executable link that will allow the Marketer to see all other information for that particular entry in the database. This will be displayed in the DATABASE MATCH INFORMATION SCREEN.

The Marketer then has an option to ADD SEARCH TO SHOPPING CART. This option allows the Marketer to save searches that have been performed in a data table that serves as a storage space for Marketer searches. The saved search is placed in the shopping cart as CONFERENCE, SEARCH TERM+(FIELD), SEARCH TERM+(FIELD), SEARCH TERM+(FIELD), SEARCH TERM+(FIELD), SEARCH TERM+(FIELD), SEARCH TERM+(FIELD), DATE OF SEARCH.

The Marketer then markets directly to database entries attending the specified conference based on information obtained from database mining.

As a specific example of the above embodiment, consider the following:

SNPSCORE is a small biotechnology firm that markets SNP detection kits for use with the ABI 7700 Sequence Detection System. SNPSCORE's main market consists of organizations engaged in pharmacogenetics research. SNPSCORE is going to attend the 4^{th} Annual Meeting of the Pharmacogenetics Research Network, which will take place from Mar. 5^{th} to Mar. 7^{th}, 2004. SNPSCORE would like to identify prospective customers who are going to attend this conference.

First, SNPSCORE accesses the database, enters the appropriate login information, and selects “4^{th} Annual Meeting of the Pharmacogenetics Research Network—Los Angeles. Calif., Mar. 5, 2004-Mar. 7, 2004” from the CONFERENCE SEARCH SCREEN. SNPSCORE performs this search on Feb. 15^{th}, 2004.

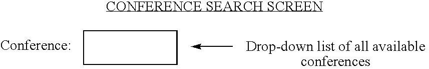

SNPSCORE is then directed to the INTRO SEARCH SCREEN search, where SNPSCORE can search all attendees of this conference by any or all the following six fields:

INTRO SEARCH SCREEN

| | |
|---|---|
| Research Focus | 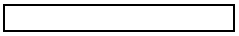 |
| Name | 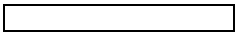 |
| Equipment | 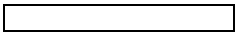 |
| Software | 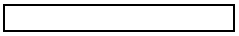 |
| Geographical Location | 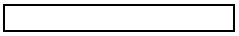 |
| Institution | 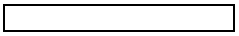 |

SNPSCORE searches the attendee list by RESEARCH FOCUS: Pharmacogenetics (AND) Equipment: ABI on Mar. 7, 2004.

The SEARCH RESULTS SCREEN returns the following:

| Search Terms | Number of Results |
|---|---|
| Pharmacogenetics (Research Focus) + | 104 |
| ABI (Equipment) | |

SNPSCORE is presented with three options: SEARCH NEW CONFERENCE, SEARCH USING NEW TERMS, REFINE SEARCH or ACCEPT SEARCH RESULTS. In this example, SNPSCORE wishes to identify potential customers who reside in San Francisco. SNPSCORE chooses REFINE SEARCH, and adds the term “San Francisco” in the Geographical Location field.

The REFINED SEARCH RESULTS SCREEN returns the following:

| | Number of |
|---|---|
| Search Terms | Results |
| Pharmacogenetics(Research Focus) + ABI (Equipment) + | 8 |
| San Francisco (Geographical Location) | |

SNPSCORE is again presented with three options: SEARCH NEW CONFERENCE, SEARCH USING NEW TERMS, REFINE SEARCH or ACCEPT SEARCH RESULTS. In this example, SN PSCORE chooses ACCEPT SEARCH RESULTS

Search results are then ranked according to the statistical following statistical algorithm: A1*A2*A3*A4*A5*A6 . . . *A∞, where A represents the number of times the Marketer-specified search term(s) is(are) found in the corresponding data table(s) for each of the fields (fields 1, 2, 3, 4, 5, 6 . . . ∞) used to search the database. SNPSCORE is presented with a list of database matches on the MATCH SCREEN, with the first match having the highest value for the ranking statistic, and the last match having the lowest value for the ranking statistic for all 8 results.

MATCH SCREEN

| Database Match | Ranking Statistic |
|---|---|
| Doe, John | 18 |
| Smith, Jane | 12 |
| Jones, Bob | 12 |
| Brown, Ed | 9 |
| Nickels, Roberta | 6 |
| Edwards, Jason | 2 |
| Richardson, Julie | 2 |
| Powers, Matthew | 1 |

SNPSCORE is interested all database matches, so SNPSCORE collects the email addresses of all matches from the DATABASE MATCH INFORMATION SCREEN (described in section example 3) for each match. SNPSCORE is then presented with the option to ADD SEARCH TO SHOPPING CART. In this example, SNPSCORE chooses ADD SEARCH TO SHOPPING CART. The search is then saved as: 4^{th} Annual Meeting of the Pharmacogenetics Research Network—Los Angeles, Calif., Mar. 5, 2004-Mar. 7, 2004, Pharmacogenetics (Research Focus)+ABI-(Equipment)+San Francisco (Geographical Location), Feb. 15, 2004.

SNPSCORE then emails all database matches, using the email addresses obtained from the DATABASE MATCH INFORMATION SCREEN, to alert these potential customers of special promotions offered to them based on information obtained about them from the DATABASE MATCH INFORMATION SCREEN.

### Other Embodiments

The detailed description set-forth above is provided to aid those skilled in the art in practicing the present invention. However, the invention described and claimed herein is not to be limited in scope by the specific embodiments herein disclosed because these embodiments are intended as illustration of several aspects of the invention. Any equivalent embodiments are intended to be within the scope of this invention. Indeed, various modifications of the invention in addition to those shown and described herein will become apparent to those skilled in the art from the foregoing description which do not depart from the spirit or scope of the present inventive discovery. Such modifications are also intended to fall within the scope of the appended claims.

What is claimed is:

1. A marketing system comprising:
receiving means for receiving a request for at least one researcher characteristic from a database comprising an array of researcher characteristics, said array comprising researcher characteristics meeting marketer criteria for predicting a likelihood of future sales to the researcher;
filtering means for filtering the array of researcher characteristics in order of relevance to the requested characteristic; and
delivery means for delivering the relevant filtered researcher characteristics derived from the filtered array.

2. A system according to claim 1, wherein the filtering means comprises an algorithm for analyzing researcher characteristics within the database.

3. A system according to claim 2, wherein the algorithm ranks researcher characteristics selected from the group consisting of recent grant applications, recent publications, history of attending research-oriented events, purchase history of the laboratory, research focus of the laboratory, techniques used under the research focus, geography, contact information for members of the laboratory, services provided by the laboratory, world wide web address associated with the laboratory, individual and group research survey information, equipment, consumables and software accessible to the individual or group, URL, and any combination thereof.

4. A system according to claim 2, wherein the algorithm is represented by the formula: A1*A2*A3*A4*A5*A6 . . . *A∞, where A represents the number of times the Marketer-specified search term(s) is(are) found in the corresponding data table(s) for each of the fields (fields 1, 2, 3, 4, 5, 6 . . . ∞) used to search the database.

5. A system according to claim 1, wherein the array comprises at least one set of researcher characteristics.

6. A system according to claim 5, wherein the set of researcher characteristics is populated with at least one characteristic.

7. A system according to claim 6, wherein the characteristic is selected from the group consisting of recent grant applications, recent publications, history of attending research-oriented events, purchase history of the laboratory, research focus of the laboratory, techniques used under the research focus, geography, contact information for members of the laboratory, services provided by the laboratory, world wide web address associated with the laboratory, individual and group research survey information, equipment, consumables and software accessible to the individual or group, URL, and any combination thereof.

8. A system according to claim 1, wherein the database comprises an architecture selected from the group consisting of SQL, ASP, Cold Fusion, Sparc, Microsoft Access, Oracle and DB2.

9. A system according to claim 1, wherein receiving means is selected from the group consisting of a graphical user interface, telephonic marketer-to-marketer interface, text based interface, and any combination thereof.

10. A system according to claim 1, wherein the delivery means is selected from the group consisting of e-mail, graphical user interface, fax, and any combination thereof.

11. A method for generating revenue comprising:
selling the set of filtered researcher characteristics derived from the system of claim 1.

12. A method according to claim 11, wherein the filtered researcher characteristics are provided by a user keying in the researcher characteristic, and wherein the algorithm analyzes researcher characteristics within the database.

13. A method according to claim 12, wherein the algorithm compares the researcher characteristic request to the database of researcher characteristics selected from the group consisting of recent grant applications, recent publications, history of attending research-oriented events, purchase history of the laboratory, research focus of the laboratory, techniques used under the research focus, geography, contact information for members of the laboratory, services provided by the laboratory, world wide web address associated with the laboratory, individual and group research survey information, equipment, consumables and software accessible to the individual or group, URL, and any combination thereof.

14. A method for generating revenue comprising:
selling the system of claim 1.

15. A method for generating revenue comprising:
selling access to the system of claim 1.
